(19) United States
(12) Patent Application Publication
(10) Pub. No.: US 2008/0146163 A1
(43) Pub. Date: Jun. 19, 2008

(54) DIVERSITY CONTROL OF MULTI-MODE COMMUNICATION DEVICES

(75) Inventors: Jose E. Korneluk, Lake Worth, FL (US); George C. Anderson, Sunrise, FL (US); John M. Burgan, North Palm Beach, FL (US); Thomas E. Stichelbout, Aalborg (DK)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/611,055

(22) Filed: Dec. 14, 2006

(51) Int. Cl. H01Q 21/28

(52) U.S. Cl. 455/73

(57) ABSTRACT

A method of managing antenna usage within a communication device can include determining selected transceivers of a plurality of transceivers requiring a connection with an antenna (410) and identifying diversity requirements for the selected transceivers (420). A plurality of antennas can be allocated among the selected transceivers according to the diversity requirements (425, 430).

### BACKGROUND OF THE INVENTION

1. Field of the Invention

The present invention generally relates to communication devices and, more particularly, to multi-mode communication devices having a plurality of wireless transceivers and antennas.

2. Background of the Invention

Many modern communication devices incorporate multiple transceivers to facilitate communication over more than one network. For example, some mobile stations, such as those available from Motorola, Inc. of Schaumburg, Ill., have begun to offer mobile stations capable of communicating over CDMA and iDEN networks. (Motorola and iDEN are trademarks of Motorola, Inc. in the United States, other countries, or both). These communication devices can be said to be “multi-mode”.

Other examples of communication devices having multiple transceivers can include mobile stations that communicate over mobile phone network(s) as well as over one or more short range wireless networks such as an IEEE 802 wireless network or a Bluetooth® wireless network. Mobile stations typically include Bluetooth transceivers for communicating with wireless peripheral devices such as earpieces and the like. These various transceivers within the communication device often operate concurrently and independently of one another. This functionality allows the user to engage in a telephone conversation on the mobile station while also sending or receiving data in one or more other formats. For instance, the user can browse the Internet, communicate data files, and communicate via electronic mail.

Typically, each transceiver is coupled to an antenna that is suited for use within a frequency range over which the coupled transceiver is intended to operate. In cases where the transceiver is intended to operate in a diversity mode, that is, utilize more than one antenna in an attempt to increase the quality of the received signal, each such transceiver can be coupled to more than one antenna.

### SUMMARY OF THE INVENTION

The present invention relates to a method of managing antenna usage within a communication device. The method can include determining selected transceivers of a plurality of transceivers requiring a connection with an antenna and identifying diversity requirements for the selected transceivers. A plurality of antennas can be allocated among the selected transceivers according to the diversity requirements. Allocated antennas further can be connected with the selected transceivers.

Allocating the plurality of antennas can include assigning at least two antennas to each selected transceiver having a diversity requirement, assigning at least one antenna to each transceiver requiring an antenna, and/or assigning antennas to selected transceivers according to a priority associated with each transceiver. The priority for one or more of the transceivers can be varied according to an operating state of the communication device.

The method also can include disabling one of the plurality of transceivers, selecting an alternate transceiver to be used in lieu of the disabled transceiver, and disconnecting one or more antennas from the disabled transceiver and connecting the antenna(s) to the alternate transceiver.

Baseband modules further can be selectively connected with different ones of the plurality of transceivers according to the diversity requirements.

The present invention also relates to a communication device. The communication device can include a plurality of antennas, a plurality of transceivers, and a controller determining an allocation of the plurality of antennas among different ones of the plurality of transceivers according, at least in part, to diversity requirements of the plurality of transceivers.

The controller can connect the plurality of antennas with the plurality of transceivers according to the allocation. In one arrangement, the controller can connect unallocated antennas to transceivers of the plurality of transceivers that do not have a diversity requirement. In another arrangement, the controller can allocate at least one antenna to each transceiver requiring an antenna. The controller further can allocate at least two antennas to each transceiver requiring an antenna and having a diversity requirement.

The controller also can determine the allocation according to a priority associated with each of the plurality of transceivers. The priorities of one or more of the transceivers can be dynamically varied by the controller according to an operating state of the communication device.

In another arrangement, the communication device also can include a plurality of baseband modules and a baseband controller connecting selected baseband modules with selected ones of the plurality of transceivers. The baseband controller can connect a selected baseband module with at least two of the plurality of transceivers. Each of the two, or more, transceivers can be connected by the controller with at least one antenna of the plurality of antennas. The baseband controller can connect the selected baseband module with a transmitter channel and a receiver channel of a first of the two transceivers and connect the selected baseband module with the receiver channel of the second of the two transceivers.

The present invention also relates to a communication device including a plurality of antennas, a plurality of transceivers, a plurality of baseband modules, a diversity controller and a baseband controller. The diversity controller can selectively connect different ones of the plurality of transceivers with different ones of the plurality of antennas according, at least in part, to diversity requirements of the plurality of transceivers. The baseband controller can connect selected baseband modules with selected ones of the plurality of transceivers. The baseband controller further can connect one of the plurality of baseband modules to at least two transceivers according to the diversity requirements.

### BRIEF DESCRIPTION OF THE DRAWINGS

Preferred embodiments of the present invention will be described below in more detail, with reference to the accompanying drawings, in which:

FIG. 1 depicts a block diagram of a communication device that is useful for understanding the present invention;

FIG. 2 depicts a protocol stack having a plurality of protocol layers that is useful for understanding the present invention;

FIG. 3 depicts another block diagram of the communication device of FIG. 1 that is useful for understanding the present invention;

FIG. 4 is a flowchart presenting a method that is useful for understanding the present invention; and

FIG. 5 is a flowchart presenting a method that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to allocating individual ones of a plurality of antennas among a plurality of transceivers of a communication device. The antennas can be allocated among the transceivers according to any of a variety of factors and/or requirements. In one aspect antennas can be assigned to transceivers according to whether the transceiver has indicated a need for a connection. In another aspect, antennas can be assigned to transceivers according to whether one or more of the transceivers have a diversity requirement or according to priorities that can be assigned to the transceivers.

Accordingly, one or more elements of an antenna array can be connected to one or more transceivers to support simultaneous operation of multiple transceivers. As such, each transceiver can be connected to one or more antennas. Unused transceivers can be disconnected from antennas such that those antennas can be re-allocated to other transceivers. Other features of the present invention will be discussed with reference to the figures below.

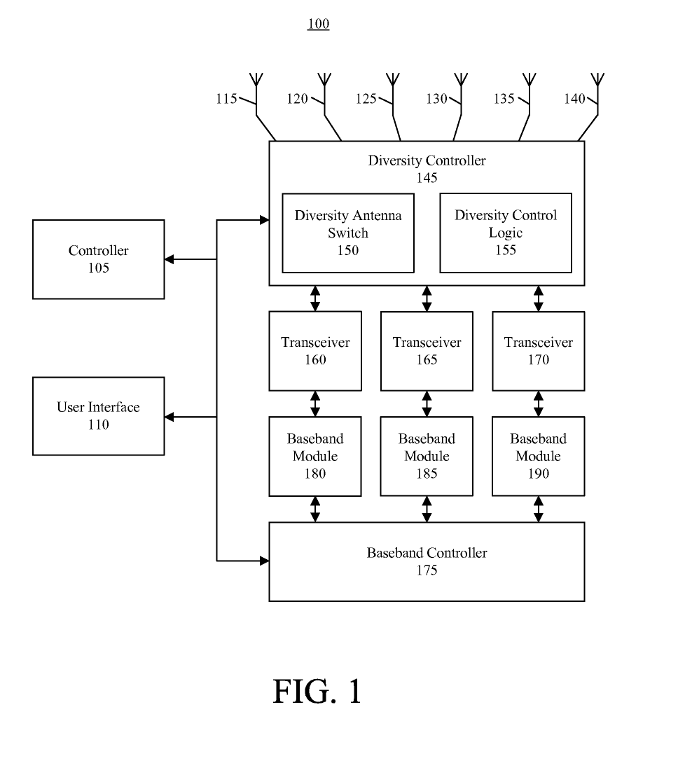

FIG. 1 depicts a block diagram of a communication device 100 that is useful for understanding the present invention. As shown, the communication device 100 can include a controller 105, a user interface 110, a diversity controller 145, and a baseband controller 175. The communication device 100 further can include a plurality of antennas 115, 120, 125, 130, 135, and 140, a plurality of transceivers 160, 165, and 170, as well as a plurality of baseband modules 180, 185, and 190.

The user interface 110 can include one or more keys which can be disposed within a keypad, one or more programmable keys, or both. The user interface 110 further can include a display as well as various other mechanisms for obtaining user input and providing feedback to a user. For example, the communication device 100 can include various sensors, audio input and output transducers, etc.

The controller 105, the diversity controller 145, and the baseband controller 175 each can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. These components can be coupled together to perform various processing functions as described herein.

In one arrangement, the controller 105 can coordinate operations between the diversity controller 145 and the baseband controller 175. The controller 105 further can process user inputs received via the user interface 110 as well as write data to the user interface 110. It should be appreciated, that while the controller 105, the diversity controller 145, and the baseband controller 175 are shown as distinct objects, each can be combined into a single controller, two controllers, or split into additional controllers as the case may be. Those skilled in the art will appreciate that one or more of the functions described herein can be implemented within a general purpose controller or a special purpose controller, as hardware, software, or a combination of both. In one arrangement, for example, one or more controllers can execute computer program code as part of the baseband portion of the communication device 100 to perform one or more of the functions described herein.

The diversity controller 145 can include a diversity antenna switch 150 and diversity control logic 155. The diversity antenna switch 150 can make connections between different ones of the transceivers 160-170 and different ones of the antennas 115-140. In one arrangement, the diversity antenna switch 150 can connect a single transceiver with a plurality of antennas, connect one or more antennas to each transceiver, or disconnect one or more antennas from one or more transceivers. The diversity antenna switch 150 can operate under the control of the diversity control logic 155.

The diversity control logic 155 can determine which of the plurality of antennas 115-140 will be allocated and connected to, which of the plurality of transceivers 160-170. The diversity control logic 155 can determine an allocation of the antennas 115-140 among the various transceivers 160-170 according to one or more parameters including, but not limited to, a need of a transceiver to be connected to an antenna, a diversity requirement, a priority of the transceiver, or the like. It should be appreciated that one or more of the factors noted herein can be dictated and/or determined according to the particular state in which the communication device 100 is operating.

A diversity requirement, as used herein, can refer to whether a given transceiver is able or required to communicate in a diversity mode. In some cases, depending upon the communication protocol implemented by the transceiver, the diversity requirement can be a static requirement in that the transceiver will always be in diversity mode or will never be in diversity mode. In other cases, the diversity requirement can be dynamic in that the transceiver can transition into and out of a diversity mode according to the operating state of the communication device 100. For example, upon a start-up or a power-on condition in the communication device 100, a transceiver may be permitted to be in a non-diversity mode. After power-up, the transceiver may be required to enter a diversity mode, for instance, when a network connection is established.

The priority of a transceiver can be assigned on a per transceiver basis and, further, can vary according to the operating state of the communication device 100. For example, a transceiver that is dedicated to voice communications, i.e., calls, can be given a higher priority than a transceiver that is tasked with text messaging. Operating states also can be indicative of conditions such as a fault condition in a transceiver where the transceiver discontinues operation and another transceiver may be required to begin operating in place of the transceiver that experienced the fault. Other examples can include a transceiver losing a connection, a transceiver acquiring a connection, a transceiver not being used, a transceiver being used, a power-on condition where the transceivers 160-170 may scan for available network connections, a particular transceiver requiring diversity and, therefore, an additional antenna, etc.

Each of the transceivers 160-170 can be RF transceivers capable of modulating and demodulating signals to convert signals from one form to another. The transceivers 160-170 can receive and/or transmit such signals over various wireless communication networks (not shown). In illustration, the transceiver 160 can be configured to communicate data via IEEE 802 wireless communications, for example, 802.11 and 802.16 (WiMax), WPA, or WPA2. The transceiver 165, for example, can communicate data via GSM, TDMA, CDMA, WCDMA, or direct wireless communication. Fewer or additional transceivers can be included within the communication device 100. As such, the particular number of transceivers included within the communication device 100 and/or the particular communication protocols used are not intended to limit the present invention.

The antennas 115-140 can be configured as independent antennas, where one or more of the antennas are suited to receiving and/or transmitting signals over a particular frequency range. Different ones of the antennas 115-140 can be configured for communicating within different frequency ranges, polarizations, and interference factors. In another arrangement, the antennas 115-140 can be implemented as an antenna array.

The antennas 115-140 can be included within or as part of the communication device 100. Alternatively, one or more or all of the antennas 115-140 can be included within or as part of a module that is separate from the communication device 100, but which can be connected via suitable communication links. For example, the antennas 115-140 can be implemented as part of a travel kit which can be suitably connected, for example, using an RF connector, with the communication device 100 to enhance the communication capabilities of the communication device 100.

The baseband controller 175 can selectively connect one or more of the baseband modules 180-190 with one or more of the transceivers 160-170. For example, under the control of the baseband controller 175, the baseband modules 180 and 185 can be linked to the transceiver 160, as will be described herein in further detail. In one arrangement, the connections between the baseband modules 180-190 and the transceivers 160-170, can be made according to diversity requirements and/or the availability of a transceiver to be used to provide an additional reception channel for one of the baseband modules 180-190. Baseband modules 180-190 process data in the baseband prior to modulation when transmitting data over the transceivers 160-170 or after received from the transceivers 160-170 and demodulated.

The communication device 100 further can include a data storage device (not shown). The data storage device can include, but is not limited to, a magnetic storage medium, an electronic storage medium, an optical storage medium, a magneto-optical storage medium, and/or any other storage medium suitable for storing digital information such as program code that, when executed, can cause a processor or controller, such as controllers 105, 145, and/or 175, to execute one or more of the functions described herein. In one arrangement, the data storage device can be integrated into a controller, though this need not be the case.

In operation, the diversity controller 145 can determine whether one or more of the transceivers 160-170 are in need of, e.g., have requested, a connection with one or more of the antennas 115-140. The diversity controller 145 can determine an allocation of antennas 115-140 to transceivers 160-170 according to the operating state of the communication device. As such, factors such as whether a particular transceiver has requested an antenna connection and requires diversity, the priority of a transceiver, whether the transceiver is being used, and the like can be considered by the diversity control logic 155 when allocating the antennas 115-140 to the transceivers 160-170. Once allocated, the diversity antenna switch 150 can connect the antennas 115-140 with the transceivers 160-170 according to the determined allocation.

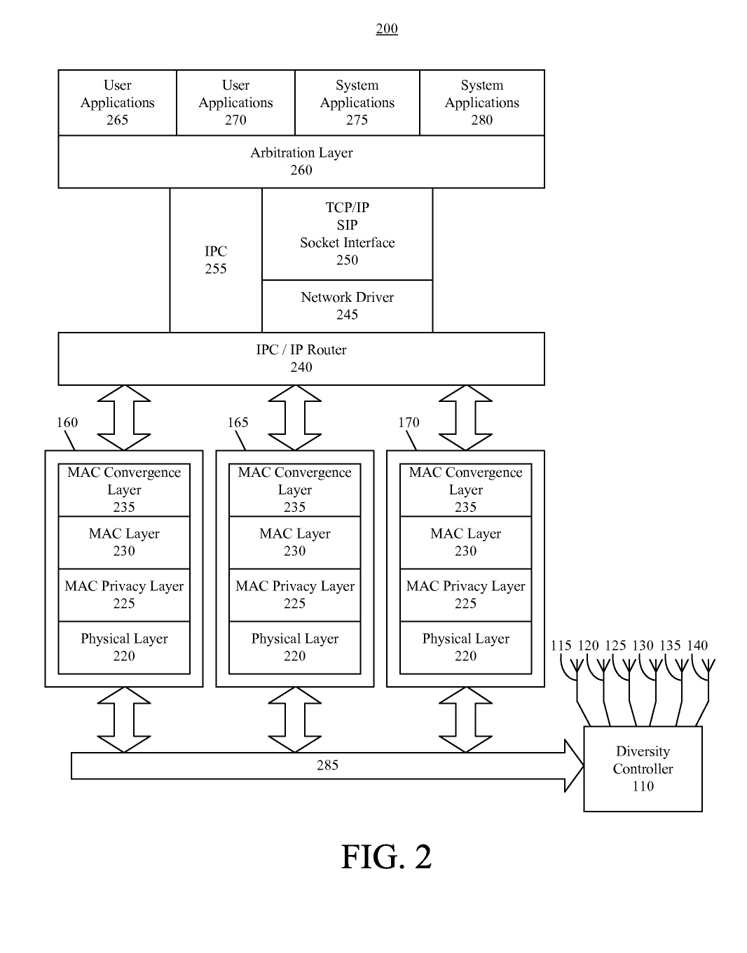

FIG. 2 depicts a protocol stack 200 having a plurality of protocol layers that is useful for understanding the present invention. The protocol stack 200 represents protocol layers that can be implemented within a communication device implementing the processes described herein, e.g., communication device 100 of FIG. 1. The protocol stack 200 can include, for instance, a plurality of protocol layers that are implemented by the transceivers 160-170 of the communication device. For each transceiver 160-70, such layers can include a physical layer 220, a media access control (MAC) privacy layer 225, a MAC layer 230, and a MAC convergence layer 235, each of which are well known to the skilled artisan.

The protocol stack 200 also can include a plurality of protocol layers implemented by networking services. Such layers can include an Internet protocol (IP) router 240, a network driver 245, and a transmission control protocol over IP (TCP/IP) stack socket/session initiation protocol (SIP) interface 250. An inter-processor communication (IPC) layer 255 also can be provided to manage inter-processor communications between the transceivers. Again such layers are well known to the skilled artisan. The protocol stack 200 further can include an arbitration layer 260. The arbitration layer 260 can arbitrate usage of the protocol layers 220-255 by services associated with user applications 265 and 270, and system applications 275 and 280.

The transceivers 160-170 can be communicatively linked with the diversity controller 110, and therefore switched among the antennas 115-140, via a communication link 285. In one embodiment, the communication link 285 can be implemented as a communication bus. It should be appreciated, however, that any of a variety of communication link can be used and the invention is not intended to be limited to one particular type of communication link.

In any case, through communication link 285, the transceivers 160-170 can issue requests to the diversity controller 110 for connections with one or more of the antennas 115-140. These requests can be based upon various operating states within the communication device. Any of a variety of different operating state within the communication device can cause a transceiver to request a connection with an antenna. Such conditions are not intended to limit the present invention, as the particular circumstances in which a transceiver 160-170 issues a request can vary. For example, in addition to those already noted, transceivers 160-170 can issue requests for connections to antennas 115-140 based upon functions performed by the different applications, whether user applications 265-270 or system applications 275-280, where such functions are reflected in the operating state of the communication device.

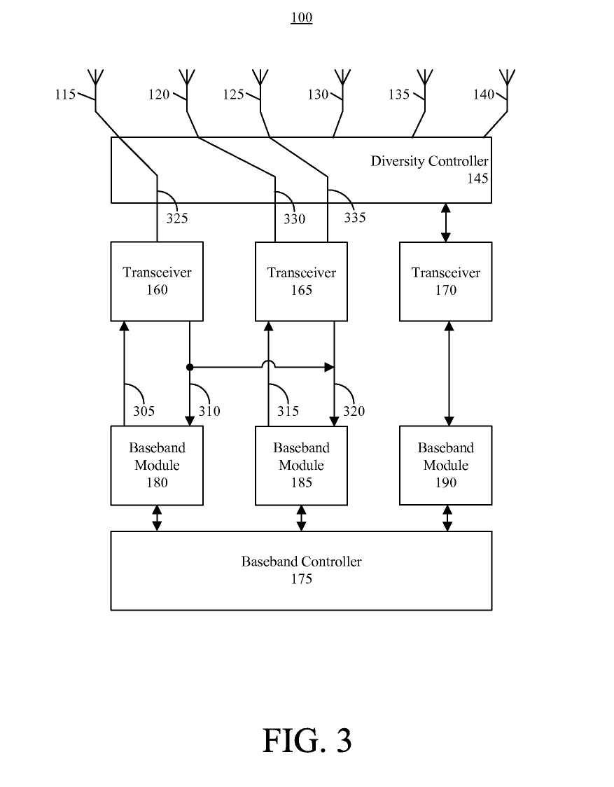

FIG. 3 depicts another block diagram of the communication device 100 of FIG. 1 that is useful for understanding the present invention. FIG. 3 illustrates an aspect of the present invention in which a baseband module, through the baseband controller 175, shares a communication path with an additional transceiver. The controller 105 and the user interface 110 have been excluded to better illustrate these aspects of the present invention. The baseband controller 175 can determine that the transceiver 160, though typically connected with, or allocated to, the baseband module 180, is not currently in use. The transceiver 165 is currently in use and connected to the baseband module 185.

In illustration, consider the case where the transceiver 160 and the baseband module 180 are configured for WLAN communications and the transceiver 165 and the baseband module 185 are configured for Bluetooth communications. As shown, under the control of the baseband controller 175, a transmission channel 305 and a reception channel 310 are formed between the baseband module 180 and the transceiver 160. Similarly, a transmission channel 315 and a reception channel 320 are created between the baseband module 185 and the transceiver 165. If the transceiver 160 is not in use, and the transceiver 165 is in use, the baseband controller 175 can cause the reception channel 310 between the transceiver 160 and the baseband module 180 to be linked with the reception channel 320 between the transceiver 165 and the baseband module 185 to create a diversity receiver for Bluetooth communications.

Operation of the diversity controller 145 can be coordinated with the operation of the baseband controller 175. In illustration, the diversity controller 145 can be aware that the transceiver 160, though not in use with the baseband module 180, is in use with the baseband module 185. When the reception channel 310 is linked with the reception channel of 320, rather than terminating the connection 325 between the transceiver 160 and the antenna 115, or providing any additional connections to other antennas, the diversity controller 145 can allow the connection 325 to remain intact. The diversity controller 145 further can maintain the connections 330 and 335 between the transceiver 165 and the antennas 120 and 125, for example, based upon diversity requirements of transceiver 165.

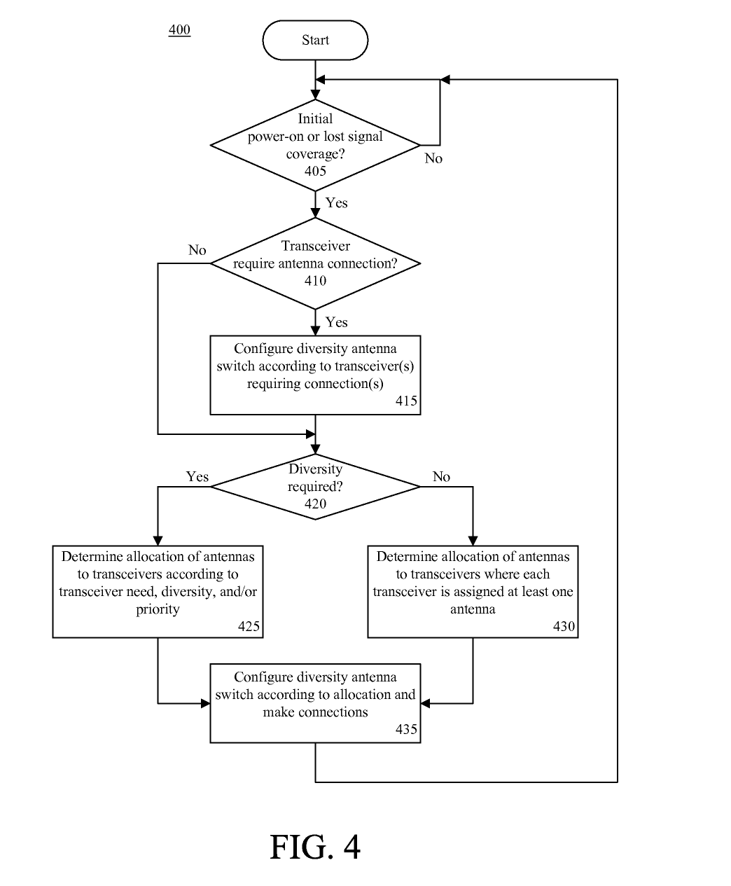

FIG. 4 is a flowchart presenting a method 400 that is useful for understanding the present invention. The method 400 can be implemented using a communication device such as the communication device described herein with reference to FIGS. 1-3. In one arrangement, the method 400 can be implemented within the communication device as a default technique for configuring transceivers and antennas.

The method 400 can begin in step 405, where a determination can be made as to whether the communication device has undergone an initial power-on condition or whether one (or more) of the transceivers has lost signal coverage, e.g., has lost a connection to a wireless network node. If the operating state of the communication device indicates either of these conditions, the method can continue to step 410. If not, the method can continue to iterate and monitor for the occurrence of one of the enumerated conditions.

In step 410, a determination can be made as to whether one or more transceivers require a connection with an antenna. If so, the method can continue to step 415. If not, the method can proceed to step 420. As noted, the transceivers can request connections with antennas for any of a variety of different reasons or responsive to any number of different conditions.

Continuing with step 415, the diversity antenna switch can be configured according to the transceivers that require connections. That is, any transceiver that requires a connection with an antenna can be connected to an available antenna. In step 420, a determination can be made as to whether any of the transceivers has a diversity requirement. If so, the method can proceed to step 425. If not, the method can continue to step 430.

In step 425, antennas can be allocated to transceivers according to transceiver need, diversity requirements, and/or priority. If one or more transceivers require connections and such transceivers have diversity requirements, those transceivers can be allocated two antennas to fulfill the diversity requirements. It should be appreciated that if a transceiver is not active, or otherwise does not require an antenna, for example, as determined by an operating state of the communication device, that transceiver need not be allocated an antenna.

In cases where contention exists for antennas, transceiver priority can be used. That is, if insufficient antennas are available to fulfill transceiver need, the transceiver priority can be used to assign antennas to those transceivers that have a higher priority than others. It should be appreciated a transceiver may have one priority when the communication device is in a particular operating state, and another priority when the communication device enters a different operating state. For example, a transceiver involved in an ongoing call, may have a higher priority than when the transceiver is not being used for such a call.

In step 430, in the case where no diversity requirements are identified, the allocation of antennas to transceivers can be such that each transceiver can be allocated, or assigned, at least one antenna. For example, each transceiver can be provided at least one antenna to allow such transceivers to concurrently scan for available network connections. This can allow transceivers to connect to available networks faster than if the transceivers scan sequentially where antennas are passed from one transceiver to the next during scanning, e.g., one transceiver scans, the antenna is connected to another transceiver, that transceiver scans, etc. It should be appreciated, however, that if sufficient antennas are available, one or more transceivers can be allocated more than one antenna if need be.

In step 435, the diversity antenna switch can be configured according to the allocation of antennas that was determined in either block 425 or block 430. Accordingly, those transceivers that require one or more antennas can be provided with the needed antennas while those transceivers that do not require connections can be disconnected or remain disconnected from antennas.

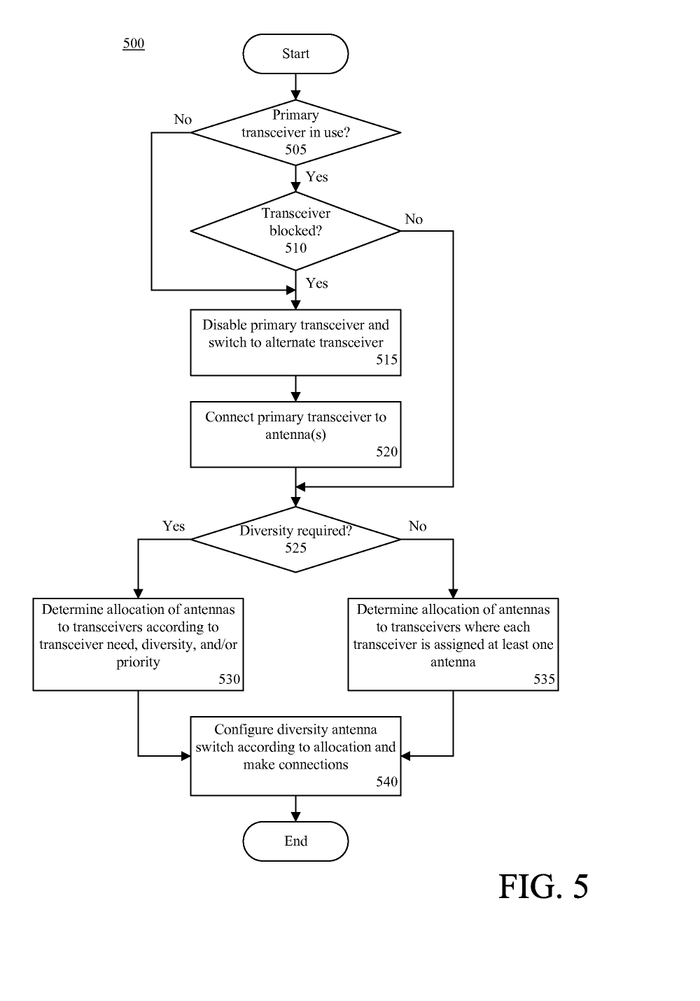

FIG. 5 is a flowchart presenting a method 500 that is useful for understanding the present invention. The method 500 can be implemented by a communication device as described with reference to FIGS. 1-3. The method 500 illustrates a technique for addressing cases in which a particular transceiver of the communication device is not functioning properly or has otherwise experienced a fault condition.

The method 500 can begin in step 505, where a determination can be made as to whether the primary transceiver is in use. If so, the method can proceed to step 510. If not, the method can continue to step 515. In one arrangement, the designation of “primary transceiver” can be one that is programmed or determined according to highest priority. If, for example, a transceiver is engaged in a voice communication, that transceiver can be considered the primary transceiver, as opposed to another transceiver that may be engaged in sending or receiving a text message. If, however, there is no ongoing call and the transceiver engaged in text messaging is the only active transceiver in the communication device, that transceiver can be considered the primary transceiver. Thus, it can be seen that the primary transceiver can be one that is determined according to the particular operating state of the communication device and can change according to the operating state.

Continuing with step 510, a determination can be made as to whether the primary transceiver is blocked. For example, a determination can be made as to whether the primary transceiver has experienced a fault condition that renders it unable to function properly or transmit or receive with the proper clarity. If the primary transceiver has been blocked or has been otherwise flagged as unavailable within the communication device, the method can proceed to step 515. If not, the method can continue to step 525.

In step 515, the primary transceiver can be disabled and an alternate transceiver can be selected and enabled. The alternate transceiver can be used in place of the disabled transceiver, effectively taking over any tasks and/or communications that were being conducted by the disabled transceiver. In this regard, the alternate transceiver can be configured to communicate using the communication protocols used by the disabled transceiver. In step 520, the alternate transceiver, which is the “new” primary transceiver, can be connected to one or more antennas as may be required. For example, the “new” primary transceiver can be connected to the antennas that previously were connected to the “prior” primary transceiver.

In step 525, a determination can be made as to whether any of the transceivers have a diversity requirement. If so, the method can proceed to step 530. If not, the method can continue to step 535. In step 530, antennas can be allocated to transceivers according to transceiver need, diversity requirements, and/or priority as discussed. In step 535, where no diversity requirements are identified, the allocation of antennas to transceivers can be such that each transceiver can be assigned at least one antenna. In step 540, the diversity antenna switch can be configured according to the allocation of antennas that was determined in either block 530 or block 535. Accordingly, those transceivers that require one or more antennas can be provided with the needed antennas while those transceivers that do not require connections can be disconnected or remain disconnected from antennas.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. Within a communication device, a method of managing antenna usage comprising:
determining selected transceivers of a plurality of transceivers requiring a connection with an antenna;
identifying diversity requirements for the selected transceivers; and
allocating a plurality of antennas among the selected transceivers according to the diversity requirements.

2. The method of claim 1, further comprising connecting allocated antennas with the selected transceivers.

3. The method of claim 1, wherein allocating the plurality of antennas further comprises assigning at least two antennas to each selected transceiver having a diversity requirement.

4. The method of claim 1, wherein allocating the plurality of antennas further comprises assigning at least one antenna to each transceiver requiring an antenna.

5. The method of claim 1, wherein allocating the plurality of antennas further comprises assigning antennas to selected transceivers according to a priority associated with each transceiver.

6. The method of claim 5, further comprising varying the priority for at least one transceiver according to an operating state of the communication device.

7. The method of claim 1, further comprising:
disabling one of the plurality of transceivers;
selecting an alternate transceiver to be used in lieu of the disabled transceiver; and
disconnecting at least one antenna from the disabled transceiver and connecting the at least one antenna to the alternate transceiver.

8. The method of claim 1, further comprising selectively connecting baseband modules with different ones of the plurality of transceivers according to the diversity requirements.

9. A communication device comprising:
a plurality of antennas;
a plurality of transceivers; and
a controller determining an allocation of the plurality of antennas among different ones of the plurality of transceivers according, at least in part, to diversity requirements of the plurality of transceivers.

10. The communication device of claim 9, wherein the controller connects the plurality of antennas with the plurality of transceivers according to the allocation.

11. The communication device of claim 9, wherein the controller connects unallocated antennas to transceivers of the plurality of transceivers that do not have a diversity requirement.

12. The communication device of claim 9, wherein the controller allocates at least one antenna to each transceiver requiring an antenna.

13. The communication device of claim 9, wherein the controller allocates at least two antennas to each transceiver requiring an antenna and having a diversity requirement.

14. The communication device of claim 9, wherein the controller further determines the allocation according to a priority associated with each of the plurality of transceivers.

15. The communication device of claim 14, wherein the controller dynamically varies the priority of at least one transceiver according to an operating state of the communication device.

16. The communication device of claim 9, further comprising:
a plurality of baseband modules; and
a baseband controller connecting selected baseband modules with selected ones of the plurality of transceivers.

17. The communication device of claim 16, wherein the baseband controller connects a selected baseband module with at least two of the plurality of transceivers, wherein each of the at least two transceivers is connected by the controller with at least one antenna of the plurality of antennas.

18. The communication device of claim 17, wherein the baseband controller connects the selected baseband module with a transmitter channel and a receiver channel of a first of the at least two transceivers and connects the selected baseband module with the receiver channel of the second of the at least two transceivers.

19. A communication device comprising:
a plurality of antennas;
a plurality of transceivers;
a plurality of baseband modules;
a diversity controller selectively connecting different ones of the plurality of transceivers with different ones of the plurality of antennas according, at least in part, to diversity requirements of the plurality of transceivers; and
a baseband controller connecting selected baseband modules with selected ones of the plurality of transceivers.

20. The communication device of claim 19, wherein the baseband controller connects one of the plurality of baseband modules to at least two transceivers according to the diversity requirements.
